(19) United States
(12) Patent Application Publication
(10) Pub. No.: US 2026/0126109 A1
(43) Pub. Date: May 7, 2026

(54) PROTECTIVE COVER

(71) Applicant: TOYOTA JIDOSHA KABUSHIKI KAISHA, Toyota-shi (JP)

(72) Inventor: Yoshiyuki FURUTA, Toyota-shi (JP)

(73) Assignee: TOYOTA JIDOSHA KABUSHIKI KAISHA, Toyota-shi (JP)

(21) Appl. No.: 19/331,434

(22) Filed: Sep. 17, 2025

(30) Foreign Application Priority Data
Nov. 6, 2024 (JP) 2024-194751

(51) Int. Cl. F16H 57/04; F16H 57/02

(52) U.S. Cl. CPC F16H 57/0412; F16H 57/02; F16H 2057/02052

(57) ABSTRACT

The heat shield member is used to protect the constant velocity joint extending in the direction of axis C, the heat shield member being made of a plate-shaped body and having an L-shape having two tip end portions when the heat shield member is unfolded in a direction perpendicular to the plate thickness direction of the plate-shaped body. The two tip end portions are provided with fastening portions each having a fastening hole, the heat shield member is configured to be mounted to the transfer in a cantilevered manner by fastening the respective fastening portions, and the cutout is provided at an edge end portion on a side of the heat shield member configured to be mounted in the cantilevered manner, the cutout being configured to suppress a localized concentration of stress due to a bending load generated in a cross-section orthogonal to a straight line connecting the fastening portions.

### CROSS-REFERENCE TO RELATED APPLICATION

This application claims priority to Japanese Patent Application No. 2024-194751 filed on November 6, 2024. The disclosure of the above-identified application, including the specification, drawings, and claims, is incorporated by reference herein in its entirety.

### BACKGROUND

### 1. Technical Field

The present disclosure relates to a protective cover that is used to protect a rotating member extending in an axial direction. The protective cover is made of a plate-shaped body and is configured in an L-shape having two tip end portions when the protective cover is unfolded in a direction perpendicular to a plate thickness direction of the plate-shaped body.

### 2. Description of Related Art

A protective cover is known that is configured to be mounted in a cantilevered manner such that a first end portion is fixed to a transfer and a second end portion is a free end. For example, the protective cover is described in Japanese Unexamined Patent Application Publication No. 2021-000862 (JP 2021-000862 A). The protective cover described in JP 2021-000862 A is provided to extend along an axis and has a semi-cylindrical shape with a semicircular cross-section, in which half of the protective cover is open in a circumferential direction. The protective cover is supported by a bearing provided between the first end portion fixed to the transfer and the second end portion that is a free end.

### SUMMARY

By the way, there is a case in which a protective cover that is used to protect a rotating member extending in an axial direction is desired to be made of a plate-shaped body and be configured in an L-shape having two tip end portions when the protective cover is unfolded in a direction perpendicular to a plate thickness direction of the plate-shaped body. In such a case, a structure in which the protective cover is supported by the bearing such as the protective cover of JP 2021-000862 A cannot be adopted. As a result, in the protective cover having the structure in which the protective cover is mounted in the cantilevered manner, there is a possibility that the protective cover is damaged due to a localized concentration of stress due to a bending load.

The present disclosure is made in view of the above circumstances, and an object of the present disclosure is to provide a protective cover that has a structure mounted in a cantilevered manner, and is capable of suppressing damage due to a localized concentration of stress due to a bending load.

The gist of the present disclosure is a protective cover that is used to protect a rotating member extending in an axial direction, the protective cover being made of a plate-shaped body and being configured in an L-shape with two tip end portions when the protective cover is unfolded in a direction perpendicular to a plate thickness direction of the plate-shaped body, in which:

fastening portions are provided at the two tip end portions of the protective cover, respectively;

the protective cover is configured to be mounted in a cantilevered manner by the fastening portions being fastened; and

a cutout is provided at an edge end portion on a side of the protective cover that is to be mounted in the cantilevered manner, the cutout being configured to suppress a localized concentration of stress due to a bending load generated in a cross-section orthogonal to a straight line connecting the respective fastening portions.

With the protective cover according to the present disclosure, the fastening portions are provided at the two tip end portions of the protective cover, respectively, the protective cover is configured to be mounted in the cantilevered manner by the fastening portions being fastened, and the cutout is provided at the edge end portion on the side of the protective cover that is to be mounted in the cantilevered manner, the cutout being configured to suppress the localized concentration of the stress due to the bending load generated in the cross-section orthogonal to the straight line connecting the respective fastening portions. As described above, in the protective cover having the structure in which the protective cover is mounted in the cantilevered manner, the cutout is provided, thereby suppressing the localized concentration of the stress due to the bending load and suppressing the damage to the protective cover.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating a schematic configuration of a vehicle on which a heat shield member according to Embodiment 1 of the present disclosure is mounted;

FIG. 2 is a view illustrating a state in which the heat shield member is mounted to the transfer through two brackets, respectively;

FIG. 3 is a perspective view of the heat shield member as seen in an arrow III direction in FIG. 2;

FIG. 4A is a view illustrating a shape of a cutout provided in the heat shield member illustrated in FIG. 3 and stress due to a bending load, and is a schematic view of the heat shield member illustrated in FIG. 3 when the heat shield member is unfolded in a direction perpendicular to a plate thickness direction;

FIG. 4B is a view illustrating a shape of a cutout provided in the heat shield member illustrated in FIG. 3 and stress due to a bending load, and is a view illustrating stress due to a bending load generated at a portion where the cutout is provided;

FIG. 5 is a schematic view of a case in which a heat shield member according to Embodiment 2 of the present disclosure is unfolded in a direction perpendicular to the plate thickness direction;

FIG. 6 is a schematic view of a case in which a heat shield member according to Embodiment 3 of the present disclosure is unfolded in a direction perpendicular to the plate thickness direction; and

FIG. 7 is a schematic view of a case in which a heat shield member according to Embodiment 4 of the present disclosure is unfolded in a direction perpendicular to the plate thickness direction.

### DETAILED DESCRIPTION OF EMBODIMENTS

The following will describe in detail each embodiment of the present disclosure with reference to the drawings. In each embodiment, the drawings are appropriately simplified or modified, and the dimensional ratios, shapes, and the like of the parts are not necessarily accurately drawn.

### Embodiment 1

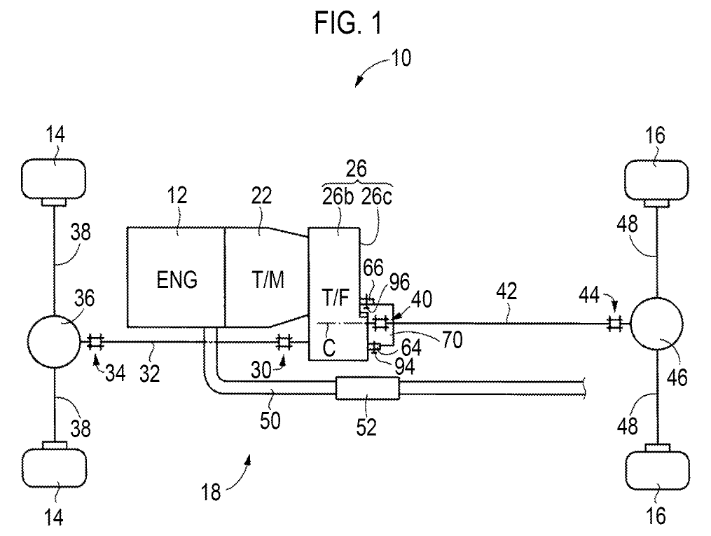

FIG. 1 is a view illustrating a schematic configuration of a vehicle 10 on which a heat shield member 70 according to Embodiment 1 of the present disclosure is mounted.

The vehicle 10 includes an engine 12 as a power source for traveling, a pair of front wheels 14 (hereinafter, simply referred to as "front wheels 14"), a pair of rear wheels 16 (hereinafter, simply referred to as "rear wheels 16"), a power transmission device 18 that transmits power of the engine 12 to the front wheels 14 and the rear wheels 16, and the like. For example, the rear wheels 16 are main drive wheels that are both drive wheels in a two-wheel drive traveling and a four-wheel drive traveling. For example, the front wheels 14 are driven wheels during in two-wheel drive traveling and are auxiliary wheels that are drive wheels during in four-wheel drive traveling. The vehicle 10 is a four-wheel drive vehicle based on a front engine rear drive (FR) system.

The engine 12 is a well-known internal combustion engine. The power transmission device 18 includes a transmission 22 in a power transmission path between the engine 12 and the transfer 26, and the transmission 22 has a well-known configuration. The transfer 26 is a well-known front-rear wheel power distribution device that distributes all of the power from the engine 12 to the rear wheels 16 or distributes the power from the engine 12 to both the front wheels 14 and the rear wheels 16. The power transmission device 18 includes, in a power transmission path between the transfer 26 and the front wheels 14, from the transfer 26 side, a constant velocity joint 30, a front propeller shaft 32, a constant velocity joint 34, a front differential gear 36, and a pair of front drive shafts 38. These components are of a known configuration. The power transmission device 18 includes, in a power transmission path between the transfer 26 and the rear wheels 16, from the transfer 26 side, a constant velocity joint 40, a rear propeller shaft 42, a constant velocity joint 44, a rear differential gear 46, and a pair of rear drive shafts 48. These components are of a known configuration. The constant velocity joint 40 extends in a direction of axis C. The axis C is the center line of rotation of the rotating shaft that connects the transfer 26 to the constant velocity joint 40.

The transfer 26 includes, for example, a disconnect clutch (not illustrated) that can engage and disengage power transmission between the transfer 26 and the front propeller shaft 32. When the disconnect clutch is disengaged, the vehicle 10 is enabled to travel with two-wheel drive. When the disconnection clutch is engaged, the vehicle 10 is enabled to travel in four-wheel drive.

The exhaust pipe 50 of the engine 12 is provided so as to extend in the front-rear direction of the vehicle 10, for example, underneath the vehicle in the vicinity of the constant velocity joint 40 that connects the transfer 26 and the rear propeller shaft 42, and is spaced from the constant velocity joint 40 at a predetermined distance. The high-temperature combustion gas output from the engine 12 is discharged through an exhaust pipe 50. For example, a well-known catalytic converter 52 is provided in the exhaust pipe 50. Since the catalytic converter 52 has a larger diameter than the exhaust pipe 50, the catalytic converter 52 is more likely to be disposed closer to the constant velocity joint 40 than the exhaust pipe 50. The catalytic converter 52 is controlled within a predetermined operating temperature range in which the purifying action is efficient and the catalytic converter 52 is not damaged.

The transfer 26 includes a transfer case 26c and a transfer main body 26b housed in the transfer case 26c. A heat shield member 70 is mounted on an outer peripheral portion of the transfer case 26c. The heat shield member 70 is a heat shield member used to shield the radiant heat from the exhaust pipe 50 (hereinafter, including the catalytic converter 52) to the constant velocity joint 40, thereby protecting the constant velocity joint 40 from the radiant heat. The constant velocity joint 40 includes a boot that prevents foreign matter from entering the constant velocity joint 40 or prevents lubricating oil inside the constant velocity joint 40 from leaking. The boot is made of an elastic material, such as synthetic rubber, to be elastically deformable, and is thermally more vulnerable compared to the heat shield member 70. The heat shield member 70 is made by, for example, pressing a metal plate that is a plate-shaped body. In a radial direction centered on the axis C, the heat shield member 70 is disposed between the exhaust pipe 50 and the constant velocity joint 40. The constant velocity joint 40 corresponds to the "rotating member" in the present disclosure. The heat shield member 70 corresponds to the "protective cover" in the present disclosure. Since the radiant heat of the exhaust pipe 50 is blocked or reflected by the heat shield member 70, the temperature rise of the constant velocity joint 40 caused by the exhaust pipe 50 is suppressed, for example. Further, for example, when the vehicle is traveling, the constant velocity joint 40 is cooled by being exposed to outside air through the portion of the constant velocity joint 40 that is not covered by the heat shield member 70.

The heat shield member 70 is mounted to the transfer case 26c of the transfer 26 via the bracket 64 and the bracket 66. The bracket 64 and the bracket 66 are well-known components that serve as connectors for mounting and supporting the heat shield member 70 to the transfer 26. The brackets 64, 66 are made of, for example, metal. The heat shield member 70 is fixed to the transfer 26 via the bracket 64 by the fastener 94 and is fixed to the transfer 26 via the bracket 66 by the fastener 96.

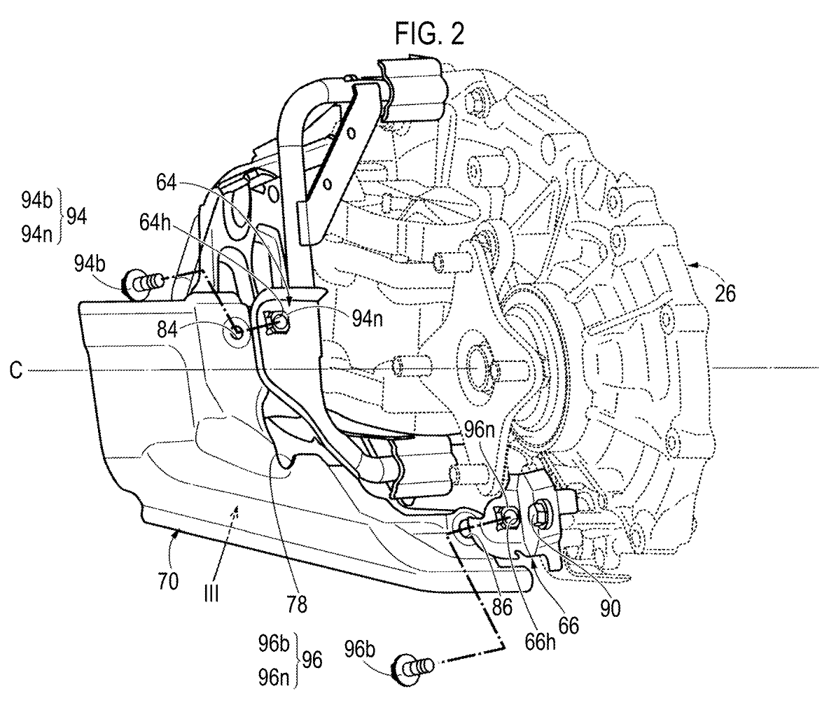

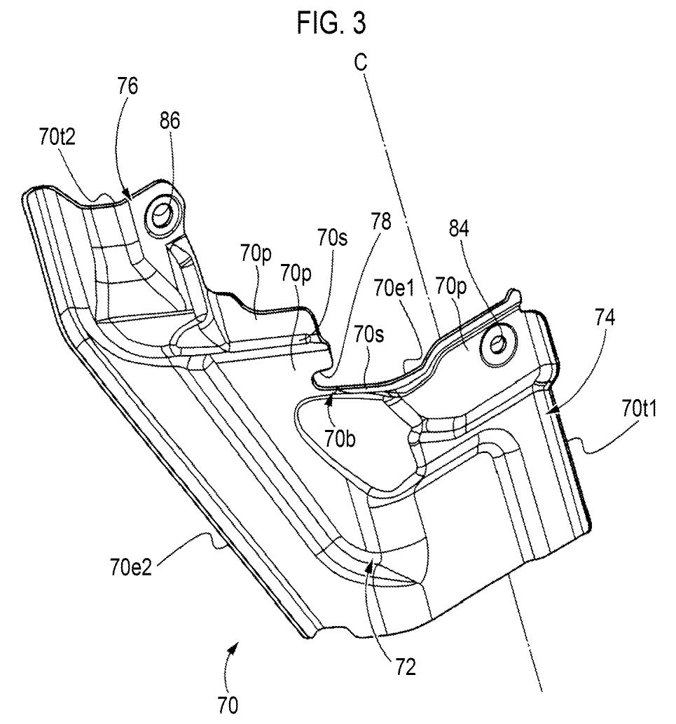

FIG. 2 is a view illustrating a state in which the heat shield member 70 is mounted to the transfer 26 through two brackets 64, 66, respectively. In FIG. 2, the transfer 26 is indicated by a broken line. FIG. 3 is a perspective view of the heat shield member 70 as seen in an arrow III direction in FIG. 2.

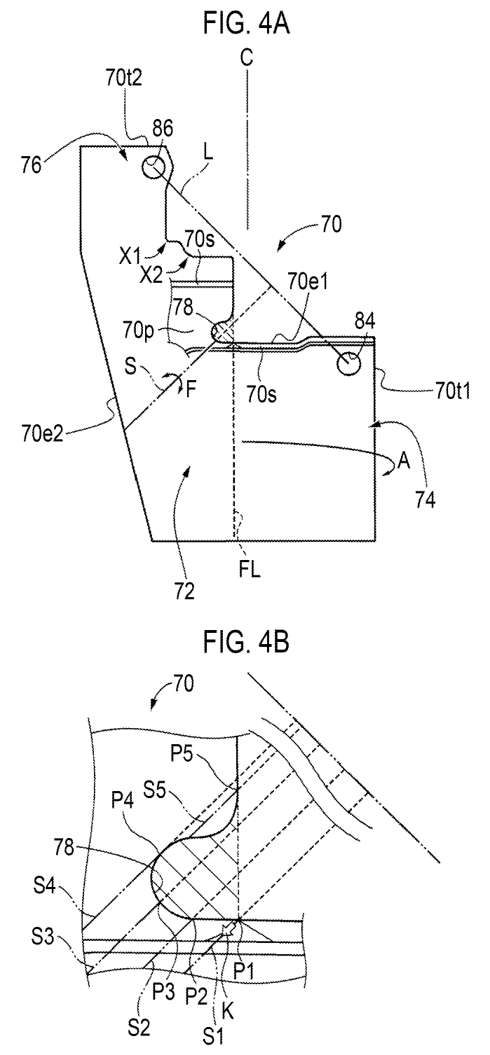

The heat shield member 70 is made of a plate-shaped body. The heat shield member 70 is bent along, for example, a fold line FL (see FIGS. 4A and 4B) that is parallel or substantially parallel to the axis C. As a result, the heat shield member 70 is configured to cover a part of the circumferential direction centered on the axis C. That is, the heat shield member 70 covers a part of the circumferential direction of the constant velocity joint 40. When the heat shield member 70 is unfolded in a direction perpendicular to the plate thickness direction of the plate-shaped body, the heat shield member 70 is configured in an L-shape (see FIGS. 4A and 4B) having two tip end portions 74, 76 that extend from the base portion 72 in directions substantially perpendicular to each other. Hereinafter, the "plate thickness direction of the plate-shaped body" is simply referred to as the "plate thickness direction".

One fastening portion 84 having a fastening hole is provided at the tip end portion 74 that is one of the two tip end portions 74, 76. One fastening portion 86 having a fastening hole is provided at the tip end portion 76 that is the other of the two tip end portions 74, 76. That is, the fastening portions are provided one at each of the two tip end portions 74, 76. The bracket 64 is fixed to the transfer 26 by, for example, a bolt (not illustrated). The bracket 66 is fixed to the transfer 26 by, for example, a bolt 90. A bolt 94b inserted through the fastening portion 84 having a fastening hole and the fastening hole 64h provided in the bracket 64 is fastened with a nut 94n. A bolt 96b inserted through the fastening portion 86 having a fastening hole and the fastening hole 66h provided in the bracket 66 is fastened with a nut 96n. The heat shield member 70 is fixed to the transfer 26 by a fastener 94 including a bolt 94b and a nut 94n and a fastener 96 including a bolt 96b and a nut 96n. In the direction of axis C, both fastening portions 84, 86 are provided on one side of the tip end portion 74 and the tip end portion 76, respectively. The heat shield member 70 is configured to be mounted to the transfer 26 in a cantilevered manner by fastening the respective fastening portions 84, 86.

When the heat shield member 70 is unfolded in a direction perpendicular to the plate thickness direction (see FIGS. 4A and 4B), the tip end of the tip end portion 74 extending from the base portion 72 in one longitudinal direction is the edge end portion 70t1, and the tip end of the tip end portion 76 extending from the base portion 72 in the other longitudinal direction is the edge end portion 70t2. One longitudinal direction and the other longitudinal direction are substantially perpendicular to each other. When the heat shield member 70 is unfolded in a direction perpendicular to the plate thickness direction, the edge end portion 70e1 is the edge end portion on the side that is mounted in a cantilevered manner, connecting one end of the edge end portion 70t1 and one end of the edge end portion 70t2. When the heat shield member 70 is unfolded in a direction perpendicular to the plate thickness direction, the edge end portion 70e2 is the edge end portion at the free end side that connects the other end of the edge end portion 70t1 and the other end of the edge end portion 70t2. The edge end portion 70e1 corresponds to the "edge end portion on the side mounted in a cantilevered manner" in the present disclosure. When the heat shield member 70 is unfolded in a direction perpendicular to the plate thickness direction, the heat shield member 70 is surrounded by the edge end portion 70t1, the edge end portion 70t2, the edge end portion 70e1, and the edge end portion 70e2.

The heat shield member 70 is provided with a plurality of flat portions 70p and a step portion 70s that is a region other than the flat portions 70p. The flat portion 70p is a flat region that is parallel or substantially parallel to the axis C. For example, the surface of the flat portion 70p is parallel to one longitudinal direction extending from the base portion 72 to the tip end portion 74 or is parallel to the other longitudinal direction extending from the base portion 72 to the tip end portion 76. The step portion 70s is a region that connects the adjacent flat portions 70p among the flat portions 70p. Specifically, the flat portion 70p is a portion that is not bent by pressing in the heat shield member 70 made of a plate-shaped body, and the step portion 70s is a portion that is bent by pressing. When the step portion 70s is provided, the overall rigidity of the heat shield member 70 is increased compared to when the step portion 70s is not provided.

A cutout 78 is provided at the edge end portion 70e1 of the heat shield member 70. As will be described later, the cutout 78 suppresses the localized concentration of stress due to the bending load F [N] generated in the cross-section S orthogonal to the straight line L connecting the two fastening portions 84, 86, respectively. The specific shape of the cutout 78 will be described later.

FIG. 4A is a view illustrating a shape of a cutout 78 provided in the heat shield member 70 illustrated in FIG. 3 and stress due to a bending load F, and is a schematic view of the heat shield member 70 illustrated in FIG. 3 when the heat shield member is unfolded in a direction perpendicular to a plate thickness direction. FIG. 4B is a view illustrating a shape of a cutout 78 provided in the heat shield member 70 illustrated in FIG. 3 and stress due to a bending load F, and is a view illustrating stress due to a bending load F generated at a portion where the cutout 78 is provided.

As described above, when the heat shield member 70 is unfolded in a direction perpendicular to the plate thickness direction, as illustrated in FIG. 4A, the heat shield member 70 is configured in an L-shape having two tip end portions 74, 76 that extend from the base portion 72 in directions substantially perpendicular to each other. The actual heat shield member 70 is bent in the direction of the arrow A along the fold line FL illustrated in FIGS. 4A and 4B. In FIGS. 4A and 4B, the region cut out by the cutout 78 is indicated by hatching.

The cutout 78 is provided by cutting out, for example, a boundary portion 70b (see FIG. 3) between the flat portion 70p and the step portion 70s, that is, a root portion of the step portion 70s in the flat portion 70p. The boundary portion 70b corresponds to the "root portion" in the present disclosure. In the present embodiment, the cutout 78 extends in a direction perpendicular to the fold line FL, cutting out a portion of the heat shield member 70. When the heat shield member 70 is unfolded in a direction perpendicular to the plate thickness direction, stress due to the bending load F is generated in the heat shield member 70 in a cross-section S orthogonal to a straight line L connecting the fastening portion 84 and the fastening portion 86, respectively. The bending load F is caused by, for example, the vibration of the engine 12.

As illustrated in FIG. 4B, the cross-section S orthogonal to the straight line L includes, for example, cross-sections S1 to S5. The cross-sections S1 to S5 are cross-sections S passing through positions P1 to P5 at the edge end of the cutout 78, respectively. In the cross-sections S1 to S4, the region adjacent to one side in the cross-sections S1 to S4 is connected to the fastening portion 84, and the region adjacent to the other side is connected to the fastening portion 86. Therefore, in each of the cross-sections S1 to S4, stress due to the bending load F is generated. In the cross-section S5, the region adjacent to one side in the cross-section S5 is not connected to any of the fastening portion 84 and the fastening portion 86, and the region adjacent to the other side is connected to both the fastening portion 84 and the fastening portion 86. Therefore, no stress due to the bending load F is generated in the cross-section S5. Among cross-sections S orthogonal to the straight line L, the cross-section S in which the region adjacent to one side is connected to the fastening portion 84 and the region adjacent to the other side is connected to the fastening portion 86 corresponds to the "location where stress due to the bending load is generated" in the present disclosure.

At a location where stress due to the bending load F is generated at the edge end of the cutout 78, the edge end of the cutout 78 is not shaped into a corner where the cutout portion has a sharp shape. That is, the edge of the cutout 78 is provided as a curve with a gradually changing curvature or a straight line that is continuously connected to the curve. For example, the cutout 78 has a shape including an arc, such as a U-shape or a semi-circular shape. When the curvature of the straight line is regarded as infinity, the curvature of the edge end of the cutout 78 changes gradually. For example, each of the positions between the positions P1 to P4 at the edge end of the cutout 78 is a location where stress due to the bending load F is generated, but the position is not shaped into a corner where the cutout portion has a sharp shape. Therefore, the stress due to the bending load F is not locally concentrated at each of the positions between the positions P1 and P4. In addition, by providing the cutout 78, the stress due to the bending load F is dispersed, and the flexibility of the heat shield member 70 to bend around each of the cross-sections S orthogonal to the straight line L connecting the respective fastening portions 84, 86 is improved.

For example, in a comparative example in which the cutout 78 is not provided, the cutout portion at the position P1 is shaped into a corner with a sharp shape. At the position P1, the curvature changes abruptly from an infinite straight line to a zero value. Therefore, in the comparative example, since the stress due to the bending load F is locally concentrated at the position P1, a crack is likely to occur in the direction indicated by the white arrow from the position P1.

In the present embodiment, the cutout 78 is provided at one location, but for example, the cutout 78 may be provided at positions X1, X2, and the like as illustrated in FIG. 4A in the heat shield member 70.

According to the present embodiment, the heat shield member 70 is used to protect the constant velocity joint 40 extending in the direction of axis C, the heat shield member 70 being made of a plate-shaped body and being configured in an L-shape having two tip end portions 74, 76 when the heat shield member 70 is unfolded in a direction perpendicular to the plate thickness direction of the plate-shaped body. Further, the two tip end portions 74, 76 of the heat shield member 70 are each provided with either the fastening portion 84 or the fastening portion 86, one each. By fastening the respective fastening portions 84, 86, the heat shield member 70 is configured to be mounted to the transfer 26 in a cantilevered manner. A cutout 78 is provided at the edge end portion 70e1 of the heat shield member 70 to suppress the localized concentration of the stress due to a bending load F generated at a cross-section S orthogonal to a straight line L connecting the respective fastening portions 84 and 86. As described above, the cutout 78 is provided in the heat shield member 70 having the structure in which the heat shield member 70 is mounted in a cantilevered manner, the localized concentration of the stress due to the bending load F is suppressed, and the damage (for example, crack) of the heat shield member 70 is suppressed.

According to the present embodiment, when the heat shield member 70 is unfolded in a direction perpendicular to the plate thickness direction, the curvature of the edge end of the cutout 78 gradually changes at a location where the stress due to the bending load F is generated in the heat shield member 70. With the shape of the cutout 78, the localized concentration of the stress due to the bending load F is effectively suppressed.

According to the present embodiment, (a) the heat shield member 70 is provided with a plurality of flat portions 70p and a step portion 70s that connects the adjacent flat portions 70p among the flat portions 70p, and (b) the cutout 78 is provided in the flat portion 70p. The overall rigidity of the heat shield member 70 is increased by providing the step portion 70s, and the heat shield member 70 is easily manufactured by pressing, by providing the cutout 78 in the flat portion 70p.

According to the present embodiment, the cutout 78 is provided by cutting out the boundary portion 70b. The step portion 70s has a higher rigidity than the flat portion 70p. Therefore, the heat shield member 70 is likely to bend locally at the boundary portion 70b where the rigidity changes abruptly due to the bending load F, and the stress due to the bending load F is likely to be locally concentrated at the boundary portion 70b. Since the cutout 78 is provided by cutting out the boundary portion 70b, a location that is likely to bend due to the bending load F tends to be dispersed away from the boundary portion 70b. As a result, the localized concentration of stress due to the bending load F is suppressed, and the damage to the heat shield member 70 is likely to be suppressed.

### Embodiment 2

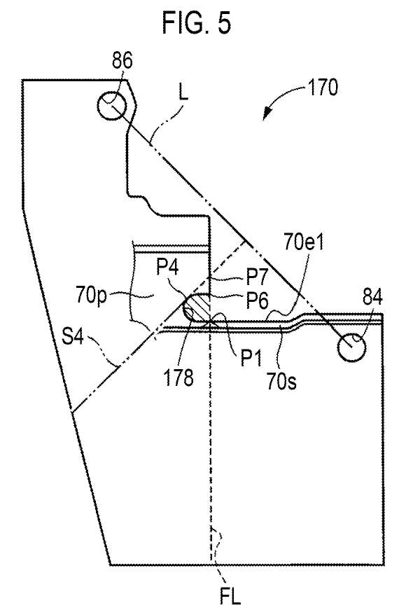

FIG. 5 is a schematic view of a case in which a heat shield member 170 according to Embodiment 2 of the present disclosure is unfolded in a direction perpendicular to the plate thickness direction. The heat shield member 170 is mounted on the vehicle 10 having the same configuration as the vehicle 10 in Embodiment 1 described above. The heat shield member 170 has substantially the same configuration as the heat shield member 70 according to Embodiment 1 described above, but is different in that the cutout is a cutout 178 instead of the cutout 78. Therefore, in the present embodiment, the description will be made focusing on the parts different from those of Embodiment 1, and the same parts as those of Embodiment 1 in the function will be denoted by the same reference numerals, and the description thereof will be appropriately omitted. The heat shield member 170 corresponds to the "protective cover" in the present disclosure.

The shape of the cutout 178 is substantially the same as the shape of the cutout 78, but the shape of the cutout 178 at a location where the stress due to the bending load F is not generated is different. That is, the shape of each of the positions between the positions P1 and P4 at the edge end of the cutout 178 is the same as the shape of the cutout 78, but the shape of each of the positions between the positions P4 and P6 at the edge end of the cutout 178 is different from the shape of the cutout 78. For example, each of the positions between the position P4 and the position P7 is a location where the stress due to the bending load F is not generated. Therefore, at each of these positions, it is not always necessary to gradually change the curvature at the edge end of the cutout 178. For example, the cutout 178 is U-shaped.

According to the present embodiment, the same effects as those of Embodiment 1 can be obtained based on the same configuration as that of Embodiment 1.

### Embodiment 3

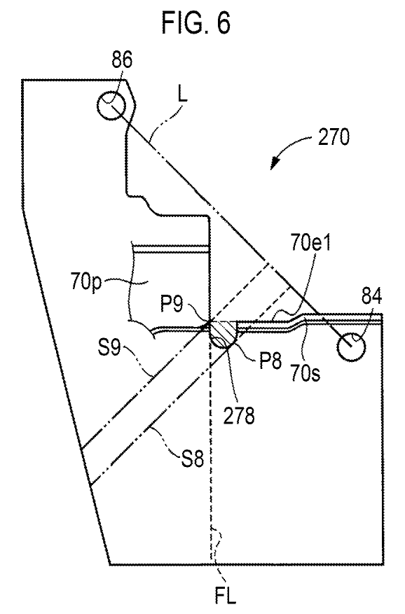

FIG. 6 is a schematic view of a case in which a heat shield member 270 according to Embodiment 3 of the present disclosure is unfolded in a direction perpendicular to the plate thickness direction. The heat shield member 270 is mounted on the vehicle 10 having the same configuration as the vehicle 10 in Embodiment 1 described above. The heat shield member 270 has substantially the same configuration as the heat shield member 70 according to Embodiment 1 described above, but is different in that the cutout is a cutout 278 instead of the cutout 78. Therefore, in the present embodiment, the description will be made focusing on the parts different from those of Embodiment 1, and the same parts as those of Embodiment 1 in the function will be denoted by the same reference numerals, and the description thereof will be appropriately omitted. The heat shield member 270 corresponds to the "protective cover" in the present disclosure.

The cross-section S8 is a cross-section S passing through a position P8 at the edge end of the cutout 278. The cross-section S9 is a cross-section S passing through a position P9 at the edge end of the cutout 278. The cutout 278 has substantially the same shape as the cutout 78, but is different in that the cutout 278 extends in a direction parallel to the fold line FL to cut out the heat shield member 270. At the edge end of the cutout 278, the location where the stress due to the bending load F is generated is each of the positions between the positions P8 and P9. Therefore, the curvature of the edge end of the cutout 278 between the positions P8 and P9 gradually changes.

According to the present embodiment, the same effects as those of Embodiment 1 can be obtained based on the same configuration as that of Embodiment 1.

### Embodiment 4

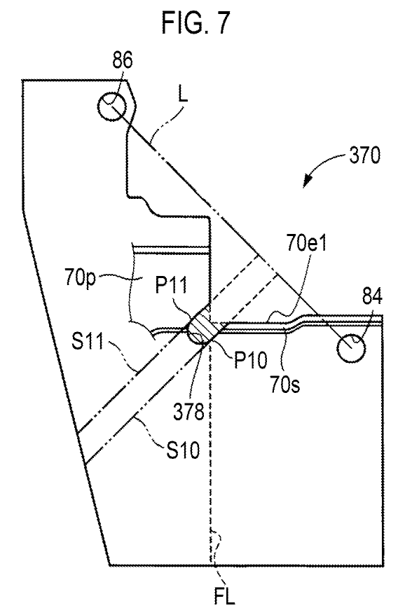

FIG. 7 is a schematic view of a case in which a heat shield member 370 according to Embodiment 4 of the present disclosure is unfolded in a direction perpendicular to the plate thickness direction. The heat shield member 370 is mounted on the vehicle 10 having the same configuration as the vehicle 10 in Embodiment 1 described above. The heat shield member 370 has substantially the same configuration as the heat shield member 70 according to Embodiment 1 described above, but is different in that the cutout is a cutout 378 instead of the cutout 78. Therefore, in the present embodiment, the description will be made focusing on the parts different from those of Embodiment 1, and the same parts as those of Embodiment 1 in the function will be denoted by the same reference numerals, and the description thereof will be appropriately omitted. The heat shield member 370 corresponds to the "protective cover" in the present disclosure.

The cross-section S10 is a cross-section S passing through a position P10 at the edge end of the cutout 378. The cross-section S11 is a cross-section S passing through a position P11 at the edge end of the cutout 378. The cutout 378 has substantially the same shape as the cutout 78. However, the fact that the cutout 378 does not extend in a direction parallel to the fold line FL or in a direction perpendicular to the fold line FL, and extends in a direction orthogonal to the straight line L (for example, a direction in which the cross-sections S10, S11 extend) to cut out the heat shield member 370 is different. At the edge end of the cutout 378, the location where the stress due to the bending load F is generated is each of the positions between the positions P10 and P11. Therefore, the curvature of the edge end of the cutout 378 between the positions P10 and P11 gradually changes.

According to the present embodiment, the same effects as those of Embodiment 1 can be obtained based on the same configuration as that of Embodiment 1.

It should be noted that the embodiments described above are the embodiments of the present disclosure, and the present disclosure can be carried out in various modified and improved aspects based on the knowledge of those skilled in the art without departing from the spirit of the present disclosure.

In Embodiments 1 to 4 described above, the cutouts 78, 178, 278, 378 are all configured to cut out the boundary portion 70b, but the present disclosure is not limited to such a configuration. For example, the cutouts 78, 178, 278, 378 may be configured to cut solely out the flat portion 70p. In such a configuration as well, the localized concentration of stress due to the bending load F in the heat shield member 70 is suppressed compared to when the cutouts 78, 178, 278, 378 are not provided, and the damage to the heat shield members 70, 170, 270, 370 is suppressed.

In Embodiments 1 to 4 described above, the heat shield members 70, 170, 270, 370 are provided with the cutouts 78, 178, 278, 378 at one location, respectively. However, the present disclosure is not limited thereto, and a plurality of the cutouts 78, 178, 278, 378 may be provided.

In Embodiments 1 to 4 described above, one fastening portion is provided at each of the two tip end portions 74, 76, but the present disclosure is not limited to such a configuration. For example, a plurality of fastening portions may be provided at the two tip end portions 74, 76. In such a configuration as well, stress due to the bending load F is generated in the cross-section S orthogonal to a straight line connecting any one of the fastening portions provided in the tip end portion 74 and any one of the fastening portions provided in the tip end portion 76. By providing the cutouts 78, 178, 278, 378, the localized concentration of stress due to the bending load F in the heat shield members 70, 170, 270, 370 is suppressed.

In Embodiments 1 to 4, the heat shield members 70, 170, 270, 370 are bent along one fold line FL that is parallel or substantially parallel to the axis C, but the present disclosure is not limited to such a configuration. For example, the heat shield members 70, 170, 270, 370 may be bent along a plurality of fold lines that is parallel or substantially parallel to the axis C.

In Embodiments 1 to 4, the "protective cover" in the present disclosure is the heat shield members 70, 170, 270, 370 that are heat insulators, but the present disclosure is not limited to such a configuration. For example, the present disclosure can also be applied to a cover used to protect a constant velocity joint from collisions with a rock or the like on a traveling road.

In Embodiments 1 to 4 described above, the vehicle 10 on which the heat shield members 70, 170, 270, 370 are mounted is a four-wheel drive vehicle based on the FR system; however the present disclosure is not limited thereto, and may be, for example, a two-wheel drive vehicle of the FR system. In addition, the present disclosure can be applied to a vehicle in which a power source for traveling is an electric motor, not the engine 12.

What is claimed is:

1. A protective cover that is used to protect a rotating member extending in an axial direction, the protective cover being made of a plate-shaped body and being configured in an L-shape with two tip end portions when the protective cover is unfolded in a direction perpendicular to a plate thickness direction of the plate-shaped body, wherein:
fastening portions are provided at the two tip end portions, respectively;
the protective cover is configured to be mounted in a cantilevered manner by the fastening portions being fastened; and
a cutout is provided at an edge end portion on a side of the protective cover that is to be mounted in the cantilevered manner, the cutout being configured to suppress a localized concentration of stress due to a bending load generated in a cross-section orthogonal to a straight line connecting the respective fastening portions.

2. The protective cover according to claim 1, wherein, when the protective cover is unfolded in the direction perpendicular to the plate thickness direction, a curvature of an edge end of the cutout gradually changes at a location where the stress due to the bending load is generated.

3. The protective cover according to claim 1, wherein:
the protective cover includes a plurality of flat portions and a step portion configured to connect adjacent flat portions to each other among the flat portions; and
the cutout is provided in the flat portion.

4. The protective cover according to claim 1, wherein:
the protective cover includes a plurality of flat portions and a step portion configured to connect adjacent flat portions to each other among the flat portions; and
the cutout is provided by cutting out a root portion of the step portion in the flat portion.

5. The protective cover according to claim 1, wherein the protective cover is configured to be mounted in the cantilevered manner by the fastening portions each being provided at a corresponding one of the two tip end portions.
